(19) United States
(12) Patent Application Publication
(10) Pub. No.: US 2007/0290098 A1
(43) Pub. Date: Dec. 20, 2007

(54) AIRFOIL HAVING A MOVABLE CONTROL SURFACE

(76) Inventors: Charlie NOVAK, Marietta, GA (US); Owen T. Berry, Marietta, GA (US); Chris J. Hardin, Woodstock, GA (US); Bobby D. McAllister, Acworth, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/620,890

(22) Filed: Jan. 8, 2007

Related U.S. Application Data
(60) Provisional application No. 60/804,903, filed on Jun. 15, 2006.

(51) Int. Cl. B64C 15/00

(52) U.S. Cl. 244/12.6

(57) ABSTRACT

An airfoil for use with an aircraft having an engine positioned such that exhaust from the engine flows under an underside of the airfoil. The airfoil includes an upper surface and a movable control element. The upper surface has a leading edge and a trailing edge. The movable control element is positioned adjacent the trailing edge and is selectively controlled for movement between a first position and a second position. In the first position, the movable control element does not mix fluid flowing over the top of the airfoil with engine exhaust under the airfoil. In the second position, at least some of the fluid flowing over the top of the airfoil mixes under the airfoil with engine exhaust.

### CROSS-REFERENCED TO RELATED APPLICATION

The benefit of the filing date of U.S. provisional patent application Ser. No. 60/84, filed Jun. 15, 2006, entitled AIRFOIL HAVING A MOVABLE CONTROL SURFACE, is hereby claimed, and the specification thereof is incorporated herein by this reference.

### TECHNICAL FIELD

The present invention generally relates to aircraft control, and more specifically, improved airfoil flaps for controlling the amount of lift and/or drag produced by an aircraft wing.

### BACKGROUND OF THE INVENTION

Generally, many types of aircraft utilize flaps to increase or decrease the amount of lift and/or drag of an aircraft wing by changing the amount of camber of the airfoil, or wing shape. The camber refers generally to the asymmetry between the top and the bottom curves of an airfoil. Typically, flaps are hinged surfaces positioned at the trailing edge of a fixed-winged aircraft's wings and which may be extendable or retractable depending on the desired amount of increase or decrease in the amount of the wings' lift and/or drag. For instance, extendable flaps are usually fully extended when an aircraft is landing to allow the craft to fly more slowly and to provide for a steeper approach to the landing site. Additionally, the flaps are often partially extended during take-off to generate more lift to help the aircraft get off the ground.

Several known types of flaps exist in the prior art, including simple plain flaps, split flaps, “Fowler” flaps, slotted flaps and blown flaps. Plain flaps are mounted at the trailing edge of a wing and simply rotate on a hinge. Plain flaps are typically used only on small aircraft such as a Cessna 172 for example. A split flap has an upper and lower airfoil trailing surface, wherein the lower surface operates like a plain flap, while the upper surface remains stationary. A Fowler flap slides backwards before the flap hinges downwardly. This motion increases both the camber and chord length of the wing for creating a larger wing surface. A slotted flap has a slot or gap between the trailing surface of the fixed wing and the flap. The slot allows some higher pressure air from below the wing to interact with the lower pressure air moving over the flap, wherein the interaction occurs above the flap. This process permits the airflow above the wing to stay attached to the flap for longer periods of time, especially in low speed conditions. Finally, blown flap systems blow engine air over the upper surface of the flap at certain angles to improve lift characteristics.

While these prior art flaps, or modifications thereof, generally provide large modulation of airfoil lift and drag, they also can induce large changes in the location of the airfoil center-of-lift. Typically, when these prior art flaps are deployed, especially in the case of the Fowler and slotted flaps, the large changes in the airfoil center-of-lift can cause the aircraft to experience large nose-down pitching moment. Therefore, these prior art flaps require large and/or all-moving elevator surfaces at the rear of the aircraft to provide rear-downward forces for aircraft pitch trimming. Additionally, these rear-downward elevator forces reduce the overall lift available to the keep the aircraft airborne.

Accordingly, it can be seen that a need exists in the art for an airfoil flap control mechanism that does significantly change the location of the airfoil center-of-lift or require large elevator surfaces at the rear of the aircraft. Therefore, it is to the provision of these needs and others that the present invention is primarily directed.

### SUMMARY OF THE INVENTION

In one aspect the present invention is an airfoil for use with an aircraft having an engine positioned such that exhaust from the engine flows under an underside of the airfoil, the airfoil having an upper surface and a movable control element. The upper surface further includes a leading edge and a trailing edge. The movable control element is positioned adjacent the trailing edge and is selectively controlled for movement between a first position and a second position. In the first position, fluid flowing over the upper surface of the airfoil does not mix substantially with engine exhaust under the airfoil. In the second position, at least some fluid flowing over the upper surface of the airfoil mixes under the airfoil with engine exhaust. Optionally, the movable control element is movable to a third position for thrust reversal in which some of the exhaust from the engine is directed at least partially forward, generally toward the leading edge of the airfoil.

In another aspect the present invention is an airfoil for use with an aircraft having an engine positioned such that exhaust from the engine flows under an underside of the airfoil, the airfoil including an upper surface and an ejector flap. The upper surface includes a leading edge and a trailing edge. The ejector flap is positioned adjacent the trailing edge and is selectively controlled to, at times, mix at least some fluid flowing over the upper surface of the airfoil with exhaust from the engine, wherein the mixing takes place at least partially beneath the airfoil.

In another aspect the present invention is an airfoil for use with an aircraft having an engine positioned such that exhaust from the engine flows under an underside of the airfoil, the airfoil including a upper surface and an ejector slot. The upper surface includes a leading edge and a trailing edge. The ejector slot is positioned between 50% and 80% of a local airfoil chord as measured from the leading edge to the trailing edge. The ejector slot is selectively controlled so as to be covered or uncovered, such as by a movable flap.

In still another aspect, the present invention is an airfoil for use with an aircraft having an engine positioned such that exhaust from the engine flows under an underside of the airfoil, the airfoil including an upper surface and a movable control surface. The upper surface includes a leading edge and a trailing edge. The movable control surface is positioned adjacent to the trailing edge and is selectively controlled for movement between a first position and a second position. When in the first position, the movable control surface does not substantially alter the flow of the engine exhaust. When in the second position, at least some of the engine exhaust is deflected by the movable control surface, wherein with the control surface deflecting at least some of the engine exhaust the effective curvature of the airfoil is such that the local center-of-lift of the airfoil remains between 25% and 50% of the local airfoil chord, as measured from the leading edge of the airfoil. Preferably, when in the second position, with the movable control surface deflecting at least some of the engine exhaust the effective curvature of the airfoil is such that the local center-of-lift of the airfoil remains between 25% and 35% of the local airfoil chord.

An advantage of the present invention is that the present invention does not induce large pitching moments and therefore can be employed on an aircraft with a much smaller conventional elevator surface at the rear of the plane. Additionally, the present invention allows for much smaller lift penalties due to pitch axis trimming. A smaller elevator further enhances the ability of the invention to operate at transonic speeds, where a smaller elevator induces substantially less drag than the larger elevator surfaces typically required for the other high-lift prior art flap systems. Another advantage of the present invention optionally includes the ability for an aircraft employed with the present invention to reverse its thrust, which can greatly improve the aircraft's landing and taxing abilities. The present invention can greatly improve thrust reversing efficiencies and significantly reduce lift in landing operations. Reduced lift on the wing after touchdown and during landing rollout causes more of the aircraft weight to be supported by the aircraft landing gear, thereby allowing aircraft brakes to be more forcefully applied without skidding, and high thrust reversing efficiency provides large thrust reversing forces to slow the aircraft.

These and other aspects, features, and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1a is a perspective view of an airfoil having a movable control surface according to a first example embodiment of the present invention configured for high-speed forward operation.

FIG. 1b is a perspective view of the airfoil of FIG. 1a configured for low-speed forward operation.

FIG. 2a is a cross-section view of the airfoil of FIG. 1a configured for high-speed forward operation.

FIG. 2b is a cross-section view of the airfoil of FIG. 1a configured for low-speed forward operation.

FIG. 2c is a cross-section view of the airfoil of FIG. 1a configured for reverse operation.

FIG. 3a is a cross-section view of an airfoil having a movable control surface according to a second example embodiment of the present invention configured for high-speed forward operation.

FIG. 3b is a cross-section view of the airfoil of FIG. 3a configured for low-speed forward operation.

FIG. 3c is a cross-section view of the airfoil of FIG. 3a configured for reverse operation.

FIG. 4a is a cross-section view of an airfoil having a movable control surface according to a third example embodiment of the present invention configured for high-speed forward operation.

FIG. 4b is a cross-section view of the airfoil of FIG. 4a configured for low-speed forward operation.

FIG. 4c is a cross-section view of the airfoil of FIG. 4a configured for reverse operation.

FIG. 5a is a cross-section view of an airfoil having a movable control surface according to a fourth example embodiment of the present invention configured for high-speed forward operation.

FIG. 5b is a cross-section view of the airfoil of FIG. 5a configured for low-speed forward operation.

FIG. 5c is a cross-section view of the airfoil of FIG. 5a configured for reverse operation.

FIG. 6a is a chart showing the lift coefficient plotted against the drag coefficient for the airfoil depicted in FIG. 4a.

FIG. 6b is a chart showing the lift coefficient plotted against the drag coefficient for the airfoil depicted in FIG. 4b.

FIG. 7 is a chart showing the lift coefficient plotted against the pitching moment of the airfoil depicted in FIGS. 4a-4c.

FIG. 8 is a chart showing the induced lift coefficient plotted against the angle of attack for the airfoil depicted in FIG. 5b.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

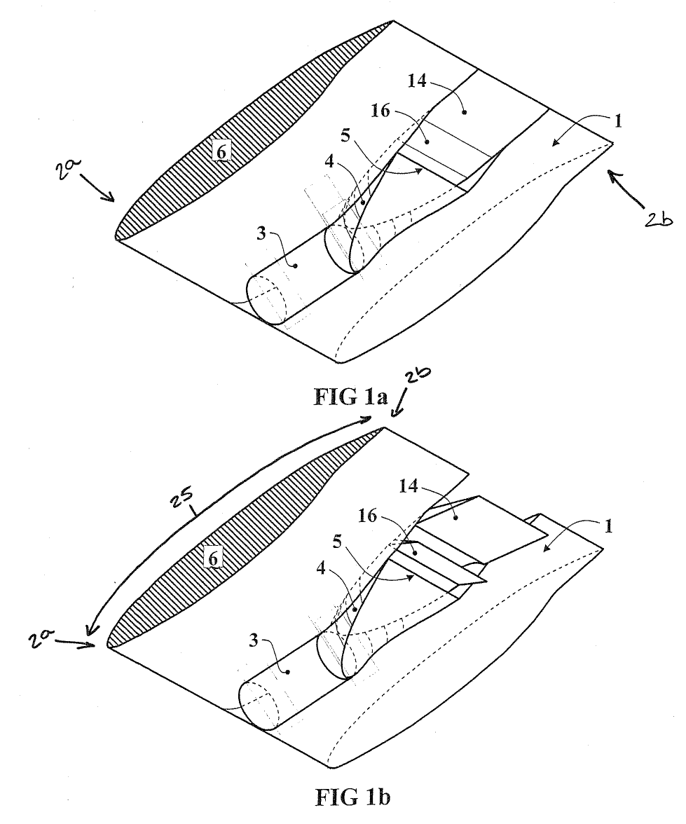

With reference now to the drawing figures, it is important to note that the present invention shall not be limited to the shape or relative size of the components as depicted in FIGS. 1a-5c, as the relative size and shape of the subsequent components of the present invention may vary with each individual application. The following description shall be construed only as a general application of principles which best embody the present invention. Generally, the present invention comprises an airfoil 1, having a cross-section 6, to be used in conjunction with a fixed-wing aircraft. Typically, the airfoil 1 works with an engine 3 having an exhaust nozzle 5 and includes mixing flap 16 and an ejector flap 14. The local airfoil 1 has a leading edge 2a and a trailing edge 2b, which define a local airfoil chord 25. The local airfoil chord 25 is measured from the leading edge 2a to the trailing edge 2b.

In example embodiments the exhaust nozzle 5 is a high-aspect ratio nozzle, as seen in FIGS. 1a & 1b. According to the present invention, the term “high aspect ratio” refers to the nozzle's 5 significantly larger width relative to its height. The nozzle 5 is positioned on the underside of the airfoil 1 behind the engine 3 to direct the flow of the engine exhaust. The engine 3 can be any one of numerous types of gas turbine engines, however, it is preferable that the engine be a low to moderate bypass-ratio gas turbine turbofan engine, which can hang just below the underside of the airfoil 1. Exhaust leaving the engine 3 is directed through a transition section 4 of the nozzle 5 before exiting the nozzle. In this respect, the transition section 4 expands the width of the exhaust flow while narrowing the exhaust flow height. Because of the nozzle's 5 high aspect ratio, the nozzle is able to project the engine exhaust flow, as it reaches the end of the nozzle, over a wide dispersement area beneath the airfoil 1. In preferred embodiments, the nozzle can be implemented on around 20% of the total available airfoil span, although, in other embodiments, this percentage can vary significantly from around 5% to 40%.

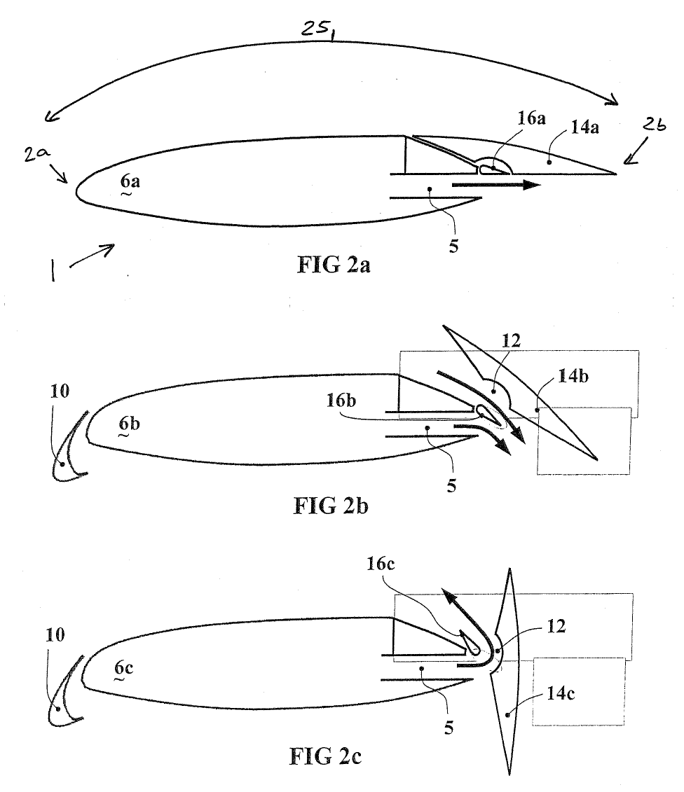

Located aft of the nozzle 5 is the mixing flap 16 and a movable ejector flap 14, as better seen in FIGS. 2a-2c. The mixing flap 16 is positioned on the underside of the airfoil 1 directly behind the nozzle 5 exit and is selectively movable between a stationary position, FIG. 2a; downward position, FIG. 2b; upward position, FIG. 2c; and numerous variations in-between. The ejector flap 14 forms at least part of the trailing edge of the airfoil 1 and is pivotably mounted at the rear of the same. The ejector flap 14 is positioned adjacent the mixing flap 16, and is selectively movable as seen in the drawing figures.

In a first airfoil position, designated as the cruise mode (FIG. 2a), the mixing flap 16 and the ejector flap 14 are positioned such that they do not significantly alter the flow of the engine exhaust leaving the nozzle 5. In this arrangement, the nozzle 5 creates a forward propulsive force on the airfoil 1 while the air traveling over the top of airfoil has the shortest distance of travel (in comparison to other trim modes for the ejector flap). As such, in the cruise mode the airfoil is configured to provide minimal drag, which is useful to maximize aircraft speed and minimize fuel consumption.

When both the ejector flap 14 and the mixing flap 16 are pivoted in the clockwise direction, an ejector slot opens up between the mixing flap and the ejector flap as seen in FIG. 2b. In preferred embodiments the ejector slot is formed at between 50% to 80% of the local airfoil chord 25, as measured from the leading edge 2a to the trailing edge 2b. In this configuration, nozzle flow is directed downwardly by the mixing flap 16, thereby inducing air flowing over the top of the airfoil 1 through the ejector slot. Additionally, it is preferred, but not necessary, that the ejector slot is configured to permit around 50% nozzle volume to flow through the slot. The rotation of the ejector flap 14 also substantially increases the effective curvature of the airfoil. This effect can be further maximized with the addition of an airfoil slat 10, which can further increase the curvature and performance of the airfoil.

In this second airfoil position, designated as the powered-lift mode, the nozzle flow creates a forward propulsive force on the airfoil 1 while causing an area of low pressure to form on the upper rear surface of the airfoil. The induced air flowing through the ejector slot substantially increases lift and drag of the airfoil 1 without significantly changing the pitching moment of the airfoil. By not significantly changing the pitching moment of the airfoil, the center-of-lift of the airfoil is able to remain between roughly 25% and 50% of the local airfoil chord 25, and more preferably 25% to 35% of the local airfoil chord, regardless of whether the airfoil is configured for cruising or powered lift.

By not inducing large pitching moments on the aircraft, the airfoil 1 design avoids typical problems associated with prior art airfoil designs. Generally, prior art airfoil flap designs provide high modulation of lift and drag but also induce large changes in the center-of-lift of the airfoil. These changes in the center-of-lift also cause large nose-down pitching moments on the aircraft which tends to force the nose of the aircraft down. To combat this problem, many aircraft have large stabilizing elevator surfaces attached to rear of the aircraft to keep the aircraft from pitching down under such circumstances. However, the large rear elevator surfaces cause a significant amount of drag on the aircraft during flight, while reducing the overall amount of lift available to keep the aircraft airborne. The present invention, when in powered lift mode (FIG. 2b), solves this problem by increasing the available lift and drag of the airfoil 1 without significantly changing the pitching moment of the airfoil, as previously described. As a result, an aircraft employing the airfoil 1 of the present invention is able to be fitted with much smaller conventional elevator surfaces and therefore is subjected to much smaller lift penalties due to pitch axis trimming caused by the same. Smaller elevator surfaces further enhances the ability of the present invention to operate at transonic speeds, where the smaller elevator induces substantially less drag than the larger elevator surfaces currently required for aircrafts utilizing prior art airfoil flaps.

In an optional third position, the mixing flap 16 can be rotated towards an upward position, wherein the flap is substantially perpendicular to the airfoil chord 25 or can even be directed towards the leading edge 2a of the airfoil 1 as seen in FIG. 2c. In this configuration, known as the thrust-reversing operation mode, the ejector flap 14 is further rotated in the clockwise direction in relation to its position described in the powered lift mode (FIG. 2b), such that the ejector flap is substantially perpendicular to the airfoil 1 body. As such, exhaust flow from the nozzle 5 can be substantially directed through the ejector slot towards the leading edge 2a of the airfoil 1, whereby a reverse propulsive force is exerted on the airfoil. This reverse propulsive force of the airfoil 1 causes a significant reduction in lift.

When the optional thrust-reversing operation mode (FIG. 2c) is employed on an aircraft, many advantages are realized over prior art high-lift systems during landing operations. For instance, the present invention can provide thrust reversing efficiencies of around 60% or greater and can significantly reduce lift on the airfoil 1 because of the reverse flow of the exhaust through the ejector slot created between the ejector flap 14 and the mixing flap 16, which forces exhaust over the upper surface of the airfoil. Reducing lift on the airfoil just after an aircraft has touched down during a landing operation and during the landing rollout causes more of the aircraft weight to be supported by the aircraft landing gear. By permitting the landing gear to support more of the aircraft's weight, the aircraft's brakes can be applied more forcefully without a skidding effect, which can allow the aircraft to stop in much shorter rollout distances compared with the prior art. Furthermore, the high thrust reversing efficiency provides large thrust reversing forces to additionally slow the aircraft.

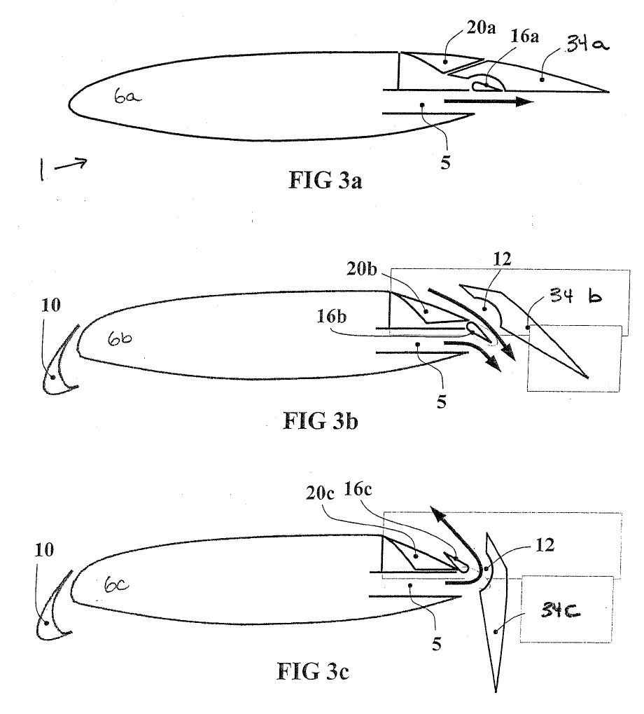

It should be clear that many variations, representing multiple embodiments of the present invention, may be formed from expanding upon the aforementioned description of the present invention depicted in FIGS. 1a-2c. Therefore, the example embodiments subsequently described herein and depicted in FIGS. 3a-5c are just a few of the multiple example embodiments that are intended to be included within the spirit and scope of the present invention and are not intended to be limiting in any way.

FIGS. 3a-3c show a variation of the invention as previously described in FIGS. 2a-2c, wherein it can be seen that the ejector flap 34 can be divided into two separate components: a smaller ejector flap 34 and an upper door 20. When the shortened ejector flap 34 is rotated from the cruising mode (FIG. 3a) into the powered lift mode, the upper door 20 drops down towards the nozzle 5 to create a smaller ejector slot as seen in FIG. 3b. Depending on the particular application of the present invention, it may be beneficial to permit a smaller volume of air to flow though the ejector slot by which a smaller amount of thrust vectoring and modulation of airfoil 1 lift and drag is provided for. When the airfoil 1 is configured for the reversing operation mode as seen in FIG. 3c, the upper door 20 can rest against the nozzle 5 to help create an ejector slot appropriate for reversing the thrust of the airfoil.

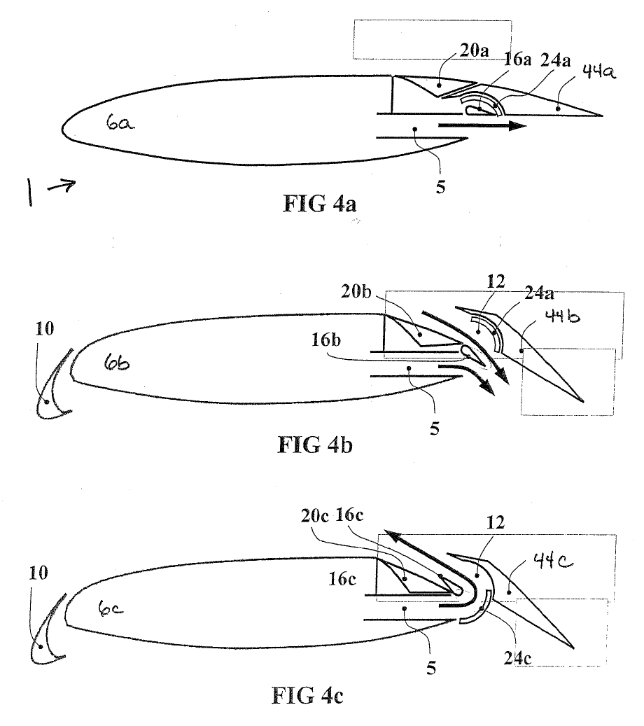

In FIGS. 4a-4c it can be seen that the airfoil 1 can be modified to include a reversing bucket 24 for increasing the reversing efficiencies of the airfoil when in the reversing operation mode as best depicted in FIG. 4c. The bucket 24 can be a flat or curved component that rests within a complementary recess in the ejector flap 44 when the airfoil is in the cruising mode (FIG. 4a) or the powered lift mode (FIG. 4b). However, when the airfoil is configured for the thrust-reversing operation mode the bucket 24 is movable from its location adjacent the ejector flap 44 to a position between the nozzle 5 and the ejector flap such that a substantial amount of the nozzle flow is deflected through the ejector slot. By deflecting such a substantial amount of the nozzle flow through the ejector slot, significantly more airfoil lift is reduced when the airfoil is operating in thrust-reversing operation mode in this embodiment over previous embodiments, allowing for shorter rollout distances.

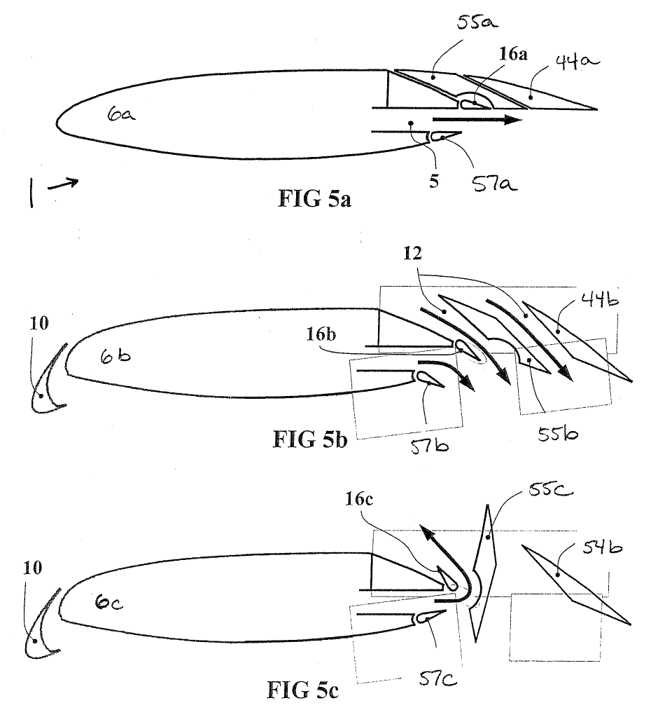

In other embodiments, additional flaps may be employed with the present invention to create a desired airfoil 1 effect. In one such embodiment, depicted in FIGS. 5a-5c, multiple ejector flaps can be used to create multiple ejector slots. In FIG. 5a the airfoil 1 is equipped with a forward ejector flap 55 separate from an aft ejector flap 54 which still forms the trailing edge 2b of the airfoil. As the airfoil 1 moves from a cruising mode (FIG. 5a) to a powered lift mode (FIG. 5b), and the ejector flaps 54,55 pivot in the clockwise direction, two ejector slots are created to allow air flowing over the top of the airfoil to be induced to flow through the slots and mix with engine exhaust as distributed by the nozzle 5. The airfoil 1 can also include a lower vectoring flap 57 to further direct the nozzle flow in the downward direction, thereby inducing greater flow through the ejector slots to provide a greater capacity for the airfoil to vector the engine thrust and modulate airfoil lift. Additionally, when the airfoil 1 is in reversing operation mode, the lower vectoring flap 57 can help vector the nozzle flow through the ejector slot for reverse thrust.

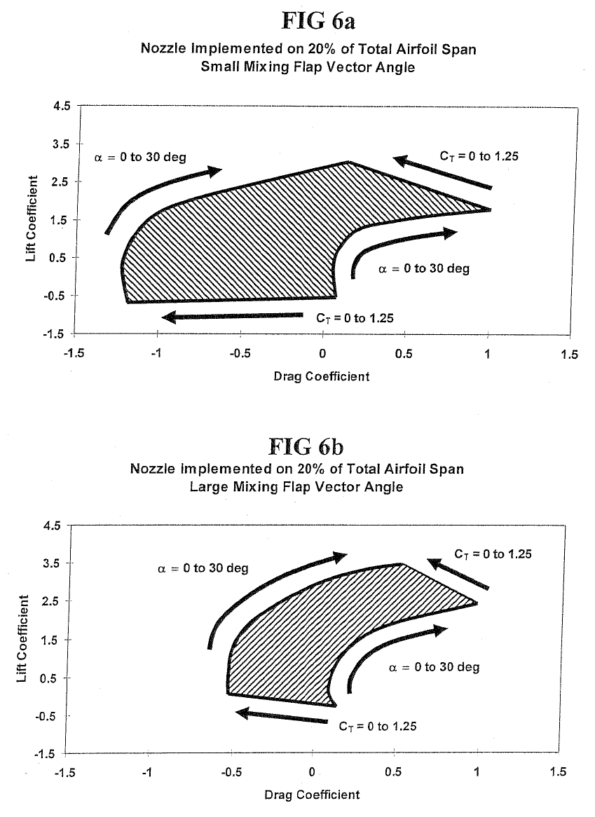

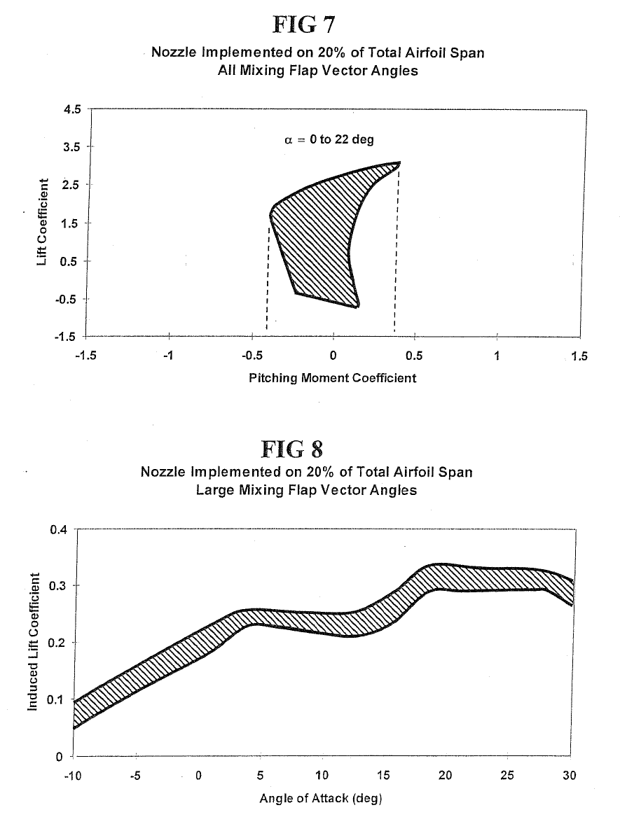

FIGS. 6a-7 show performance data for the airfoil embodiment depicted in FIGS. 4a-4c. FIG. 6a shows the lift coefficient for the airfoil plotted against the drag coefficient when the mixing flap 16 is positioned for high-speed forward operation as best depicted in FIG. 4a. FIG. 6b shows the lift coefficient for the airfoil plotted against the drag coefficient when the mixing flap 16 is positioned for low-speed forward operation as seen in FIG. 4b. FIG. 7 shows the lift coefficient plotted against the pitching moment coefficient, demonstrating the relative stationary position of the pitching moment when the airfoil changes from the cruise mode to the powered-lift mode. Finally, FIG. 8 shows induced lift coefficient plotted against the angle of attack of the airfoil depicted in FIGS. 5a-5c when configured for low-speed forward operation, generally depicting an increase in induced lift of the airfoil as a result of a greater angle of attack.

While the invention has been described with reference to preferred and example embodiments, it will be understood by those skilled in the art that a variety of modifications, additions and deletions are within the scope of the invention, as defined by the following claims.

We claim:

1. An airfoil for use with an aircraft having an engine positioned such that exhaust from the engine flows under an underside of the airfoil, the airfoil comprising:
an upper surface having a leading edge and a trailing edge; and
a movable control element positioned adjacent the trailing edge and being selectively controlled for movement between a first position in which fluid flowing over the upper surface of the airfoil does not mix substantially with engine exhaust under the airfoil, and a second position in which at least some fluid flowing over the upper surface of the airfoil mixes under the airfoil with engine exhaust.

2. An airfoil as claimed in claim 1 wherein the movable control element is movable to a third position for thrust reversal in which some of the exhaust from the engine is directed at least partially forward, generally toward the leading edge of the airfoil.

3. An airfoil as claimed in claim 1 wherein the engine is positioned beneath the airfoil.

4. An airfoil as claimed in claim 1 wherein the control element comprises a rigid, movable ejector flap positioned adjacent the trailing edge of the airfoil and a movable mixing flap positioned ahead of the ejector flap.

5. An airfoil as claimed in claim 1 wherein the control element comprises a pair of rigid, movable ejector flaps positioned adjacent the trailing edge of the airfoil, the ejector flaps being operable for creating two fluid pathways for mixing fluid flowing over the upper surface of the airfoil with engine exhaust beneath the airfoil.

6. An airfoil as claimed in claim 4 wherein the ejector flap includes a curved surface for selectively effecting thrust reversal.

7. An airfoil as claimed in claim 6 further comprising a rigid, movable thrust reversing element for cooperating with the curved surface of the ejector flap for selectively effecting thrust reversal.

8. An airfoil as claimed in claim 1 wherein the airfoil includes an ejector slot positioned between 50% and 80% of a local airfoil chord as measured from the leading edge to the trailing edge, and wherein the movable control element comprises a movable ejector flap, the ejector slot being selectively controlled so as to be covered or uncovered by the ejector flap.

9. An airfoil as claimed in claim 1 wherein the movable control element is positioned adjacent the trailing edge and is selectively controlled for movement between a first position in which the movable control element does not substantially alter the flow of the engine exhaust, and a second position in which at least some of the engine exhaust is deflected by the movable control element, wherein with the movable control element in the second position deflecting at least some of the engine exhaust the effective curvature of the airfoil is such that the local center-of-lift of the airfoil remains between 25% and 50% of the local airfoil chord, as measured from the leading edge of the airfoil.

10. An airfoil as claimed in claim 9 wherein with the movable control element in the second position deflecting at least some of the engine exhaust the effective curvature of the airfoil is such that the local center-of-lift of the airfoil remains between 25% and 35% of the local airfoil chord, as measured from the leading edge of the airfoil.

11. An airfoil for use with an aircraft having an engine positioned such that exhaust from the engine flows under an underside of the airfoil, the airfoil comprising:
an upper surface having a leading edge and a trailing edge; and
at least one ejector flap positioned adjacent the trailing edge, the at least one ejector flap being selectively controlled so as to, at times, mix at least some fluid flowing over the upper surface of the airfoil with exhaust from the engine, wherein the mixing takes place at least partially beneath the airfoil.

12. An airfoil as claimed in claim 11 wherein the ejector flap is selectively controlled to direct a portion of the engine exhaust towards the leading edge of the airfoil.

13. An airfoil as claimed in claim 11 wherein the engine is positioned beneath the airfoil.

14. An airfoil as claimed in claim 11 further comprises a movable mixing flap positioned ahead of the ejector flap.

15. An airfoil as claimed in claim 11 wherein the at least one ejector flap comprises two rigid, movable ejector flaps positioned adjacent the trailing edge of the airfoil, the ejector flaps being operable for creating two fluid pathways for mixing fluid flowing over the upper surface of the airfoil with engine exhaust beneath the airfoil.

16. An airfoil as claimed in claim 1 1 wherein the ejector flap includes a reversing bucket for selectively effecting thrust reversal.

17. An airfoil as claimed in claim 16 further comprising a rigid, movable thrust reversing element for cooperating with the reversing bucket for selectively effecting thrust reversal.

18. An airfoil as claimed in claim 11 wherein the airfoil includes an ejector slot positioned between 50% and 80% fo a local airfoil chord as measured from the leading edge to the trailing edge, and wherein the ejector slot is selectively covered or uncovered by the ejector slot.

19. An airfoil as claimed in claim 11 wherein the ejector flap is positioned adjacent the trailing edge and is selectively controlled for movement between a first position in which the ejector flap does not substantially alter the flow of the engine exhaust, and a second position in which at least some of the engine exhaust is deflected by the ejector flap, wherein when the ejector flap is in the second position the effective curvature of the airfoil is such that the local center-of-lift of the airfoil remains between 25% and 50% of the local airfoil chord, as measured from the leading edge of the airfoil.

20. An airfoil as claimed in claim 19 wherein with the ejector flap in the second position deflecting at least some of the engine exhaust the effective curvature of the airfoil is such that the local center-of-lift of the airfoil remains between 25% and 35% of the local airfoil chord, as measured from the leading edge of the airfoil.

21. An airfoil for use with an aircraft having an engine positioned such that exhaust from the engine flows under an underside of the airfoil, the airfoil comprising:
an upper surface having a leading edge and a trailing edge; and
an ejector slot positioned between 50% and 80% of a local airfoil chord as measured from the leading edge to the trailing edge, the ejector slot being selectively controlled so as to be covered or uncovered.

22. An airfoil for use with an aircraft having an engine positioned such that exhaust from the engine flows under an underside of the airfoil, the airfoil comprising:
an upper surface having a leading edge and a trailing edge; and
a movable control surface positioned adjacent the trailing edge and being selectively controlled for movement between a first position in which the movable control surface does not substantially alter the flow of the engine exhaust, and a second position in which at least some of the engine exhaust is deflected by the movable control surface, wherein with the movable control surface in the second position deflecting at least some of the engine exhaust the effective curvature of the airfoil is such that the local center-of-lift of the airfoil remains between 25% and 50% of the local airfoil chord, as measured from the leading edge of the airfoil.

23. An airfoil as claimed in claim 22, wherein with the movable control surface in the second position deflecting at least some of the engine exhaust the effective curvature of the airfoil is such that the local center-of-lift of the airfoil remains between 25% and 35% of the local airfoil chord, as measured from the leading edge of the airfoil.
